(19) United States
(12) Patent Application Publication
(10) Pub. No.: US 2022/0179717 A1
(43) Pub. Date: Jun. 9, 2022

(54) Systems and Methods for Virtual GPU-CPU Memory Orchestration

(71) Applicant: ACTIVEVIDEO NETWORKS, INC., San Jose, CA (US)

(72) Inventors: Ronald A. Brockmann, Los Gatos, CA (US); Maarten Hoeben, Acquapendente (IT)

(21) Appl. No.: 17/544,854

(22) Filed: Dec. 7, 2021

Related U.S. Application Data
(63) Continuation of application No. PCT/US2021/061958, filed on Dec. 6, 2021.
(60) Provisional application No. 63/122,441, filed on Dec. 7, 2020.

(51) Int. Cl. G06F 9/50

(52) U.S. Cl. CPC G06F 9/5077; G06F 9/5022; G06F 9/5016; G06F 9/5044

(57) ABSTRACT

A server system generates a model of a first memory architecture of a client device, the model of the first memory architecture including a GPU memory portion and a CPU memory portion. The server system receives a representation of a first image asset, and stores a first texture image corresponding to the first image asset in the GPU memory portion of the model at the server system. The first texture image is stored in the GPU memory portion of the client device. The server system determines, using the model, that the GPU memory portion at the client device needs to be reallocated. The server system identifies, using the model, one or more texture images that are stored in the GPU memory portion at the client device to evict and transmits an instruction, to the client device, to evict the one or more texture images from the GPU memory portion.

### RELATED APPLICATIONS

This application is a continuation of International Patent Application PCT/US21/61958, entitled “Systems and Methods for Virtual GPU-CPU Memory Orchestration,” filed Dec. 6, 2021, which claims priority to U.S. Provisional Patent Application No. 63/122,441, entitled “Systems and Methods for Virtual GPU-CPU Memory Orchestration,” filed on Dec. 7, 2020. This application is related to U.S. patent application Ser. No. 16/890,957, entitled “Orchestrated Control for Displaying Media,” filed on Jun. 2, 2020, which claims priority to U.S. Provisional Application No. 62/868,310, filed on Jun. 28, 2019, each of which is hereby incorporated by reference in its entirety. This application is also related to U.S. patent application Ser. No. 16/721,125, entitled “Systems and Methods of Orchestrated Networked Application Services,” filed on Dec. 19, 2019, which is a continuation of International Application No. PCT/US18/40118, filed Jun. 28, 2018, which claims priority to U.S. Provisional Application No. 62/526,954, filed Jun. 29, 2017, each of which is hereby incorporated by reference in its entirety.

### FIELD OF ART

The present invention relates generally to controlling memory allocation at a client, and more particularly to controlling, by a server, how the memory is allocated at the client based on information determined at the server.

### BACKGROUND

There is a need for systems that remotely manage content displayed on a client. However, obtaining client information for media delivery management is bandwidth consuming due to the size of graphical data.

The field of Software Virtualization generally involves the creation of a remotely accessed instance of a software program or service that is rendered to the user by a local proxy of that program such that, to the user, the service operates with all the features of and with a similar latency to a local application such that a user cannot tell that the service is remote. Virtual machines can be executed remotely to provide graphics processing and other computational tasks, as might be needed by a remote client device. Software Virtualization allows complex software systems to be maintained in a central location and accessed in the user's premises on a local computing device, smart TV, set-top box or the like.

The software systems that are most commonly virtualized utilize the Linux operating system which has become the international standard for computer systems large and small. There is an increasing demand for and use of software applications that operate in a variation of Linux called Android which powers the majority of mobile devices worldwide. This Linux variant was specifically designed for compact systems that display information controlled by gestures, such as smart phones and tablets, and is finding increasing use in smart TVs driven by the demand for living room access to the same apps that are most popular on mobile phones especially social media and video apps such as YouTube and others. Android and its applications (apps) typically require the operating system to symmetrical access to the device's memory for both the central processing unit (CPU) and the graphics processing unit (GPU). Many modern compact devices employ such a unified architecture for numerous reasons, including reduced component count as well as the flexibility to dynamically trade GPU memory for CPU memory as appropriate for the application. Because of this flexibility there is generally not an incentive for Android apps to conservatively use GPU memory.

However, problems arise when serving client devices such as cable TV set-tops and smart TVs. Due to cost constraints when manufacturing such devices, when these devices are used to control and manage the display of large amounts of video programming, there are limitations to their internal processing capabilities. This is largely due to the fact that they typically use either a unified memory architecture with a fixed division such that the CPU gets one fixed portion and the GPU the remainder or they may even have a totally discrete memory architecture, that is, separate CPU and GPU memory. The result is that such devices are not able to offer the same flexibility nor capability as a dedicated native system and the virtualized applications that run on them must deal with this memory constraint. This is the challenge to which the systems and methods of this invention provide a novel solution in order to optimize the operation of software designed for a largely unconstrained hardware environment when a virtualized version of the same software must then operating in various constrained hardware architectures.

### SUMMARY

Embodiments described herein are directed to improved systems and methods for allocating, at a server system, memory between a GPU and a CPU memory of a client device, to enable media-providing applications, which require access to media stored in the GPU, to be executed at a server.

In accordance with some embodiments, a method performed at a server computing device for remotely managing memory allocation of a client device is provided. The server system generates a model of a first memory architecture of a client device, the model of the first memory architecture including a GPU memory portion and a CPU memory portion. The server system receives a representation of a first image asset, and stores a first texture image corresponding to the first image asset in the GPU memory portion of the model at the server system. The first texture image is stored in the GPU memory portion of the client device. The server system determines, using the model, that the GPU memory portion at the client device needs to be reallocated. The server system identifies, using the model, one or more texture images that are stored in the GPU memory portion at the client device to evict and transmits an instruction, to the client device, to evict the one or more texture images from the GPU memory portion.

In some embodiments, a computer readable storage medium storing one or more programs for execution by one or more processors of an electronic device is provided. The one or more programs include instructions for performing any of the methods described above.

In some embodiments, an electronic device (e.g., a server system) is provided. The server system comprises one or more processors and memory storing one or more programs for execution by the one or more processors, the one or more programs including instructions for performing any of the methods described above.

It will be recognized that, in various embodiments, operations described with regard to the client may apply to a server and vice versa.

### BRIEF DESCRIPTION OF THE DRAWINGS

For a better understanding of the aforementioned preferred embodiments of the invention, as well as additional embodiments thereof, reference should be made to the following drawings.

FIG. 1 is a high-level block diagram of three typical memory architectures which includes a unified, unified with fixed division, and discrete memory allocation.

FIG. 2 is a high-level block diagram of a first embodiment of downloading image assets from an application backend to the client under the orchestration of the server, which acts on behalf of the virtualized application. A digest of the image asset is uploaded from the client to the server.

FIG. 3 is a high-level block diagram of a second embodiment of downloading image assets from an application backend to the client under the orchestration of the server, which acts on behalf of the virtualized application. The downloaded image asset is uploaded from the client to the server.

FIG. 4 is a high-level block diagram of a third embodiment of downloading image assets from an application backend to the server, which acts on behalf of the virtualized application. The downloaded image asset is downloaded by the client from the server.

FIG. 5 is a high-level block diagram of a first embodiment of the client-side eviction process showing the 2 states of a simple eviction process where a texture image is simply removed from GPU memory.

FIG. 6 is a high-level block diagram of a second embodiment of the client-side eviction process showing the 4 states of a more elaborate eviction process where a texture image is downloaded from GPU memory to CPU memory, subsequently evicted from GPU memory, and optionally compressed to an image asset.

FIG. 7 is a high-level block diagram of an embodiment of the client-side restoration process depicting the 4 states of the process where a texture image is decompressed from an image asset, subsequently uploaded from CPU memory to GPU memory and removed from CPU memory.

FIG. 8 is a high-level block diagram of an embodiment of the client-side texture image compression process, showing the 4 states of the process where a texture image is downloaded from GPU memory to CPU memory, compressed by the CPU in a texture image compression format supported by the GPU and subsequently uploaded to the GPU memory and removed from CPU memory.

FIG. 9 illustrates a flow chart of the server-side eviction orchestration logic

FIG. 10 illustrates a flow chart of the server-side eviction orchestration logic

FIG. 11 illustrates a flow chart of the server-side eviction orchestration logic

FIG. 12 illustrates a flow chart of the server-side eviction orchestration logic.

FIG. 13 is a flow chart of the server-side restoration orchestration logic.

FIG. 14 is a flow chart of the server-side compression orchestration logic.

FIGS. 15A-15C are flowcharts for a method of reallocating memory of a client device, in accordance with some embodiments.

FIG. 16 is a block diagram of a server system, in accordance with some embodiments.

FIG. 17 is a block diagram of a client device, in accordance with some embodiments.

### DETAILED DESCRIPTION

A virtual machine (VM) is a software emulation of a computer system which can be customized to include a predefined amount of random access memory (RAM), storage space, operating system (OS), and graphics hardware support typically in the form of a graphics processing unit (GPU); potentially in addition to other computing resources. Such virtual machines are a close equivalent of a physical computer and provide the functionality thereof.

Computer systems, either in the form of physical hardware or virtualized as a VM, typically use one of the following three memory architectures for their CPU and GPU components:
1) A unified memory architecture, where CPU and GPU share one physically contiguous memory space or at least one contiguously addressable memory space;
2) A unified memory architecture with a fixed division between memory assigned to the CPU and memory assigned to the GPU;
3) A discrete memory architecture where CPU and GPU have their own physically separated or addressably separated memory spaces.

As used herein, an image asset is a CPU domain, two-dimensional picture, compressed in a known image compression format such as, but not limited to, PNG, JPEG, WebP.

As used herein, a texture image is a GPU domain single array of texture pixels of certain dimensionality, either in an uncompressed or compressed texture image format. In some embodiments, a texture image is further enabled to be downloaded to the CPU (e.g., a CPU can interpret texture images, whereas the GPU cannot interpret image assets). In some embodiments, when a texture image is downloaded to the CPU it is optionally compressed into a image asset (e.g., as an asset in the CPU domain). For example, the texture image can be stored in the CPU as a texture image and/or as a image asset (e.g., by compressing the texture image into an image asset, as described by step 603).

Some applications typically execute on (e.g., and are designed/programmed for) systems that have a unified memory architecture. For example, many modern compact devices such as phones and tablets employ a unified memory architecture, enabling reduced component count and the flexibility to trade GPU memory for CPU memory as fit for the application then running. In contrast, the client devices being served by the approach being taught herein, typically use either a unified fixed division regime or have a complete discrete architecture. The net result is that such devices cannot offer the same flexibility as a native system would and which the applications are coded to assume.

Because the unified architecture provides such flexibility, there is generally no incentive for applications to optimize their GPU memory usage. For example, currently it is not considered an issue if all the data for a certain graphic, such as a particular texture image on the GPU, is retained, even when it is temporarily not being used, since it is the same physical memory as the CPU's memory and the system dynamically grows the amount of logical memory assigned to the GPU. In contrast for more compact and cost-efficient systems, the novel approach being taught herein enables that function to be virtualized to a client, providing the ability it to manage its GPU memory more efficiently.

In the novel unified architecture being taught herein, GPU memory texture images can be moved to CPU memory on demand in real time. As one example, if a situation arose where an application needed space for four GPU texture images, the traditional architecture, with its fixed division or discrete architecture, might only have space for three GPU texture images. Therefore, to accommodate for the additional texture image, one or more texture images have to be evicted from the GPU memory and (temporarily) stored in the CPU's memory. In contrast, the unified architecture described herein has already assigned four texture images to GPU memory and further free memory is available to either assign to CPU or GPU.

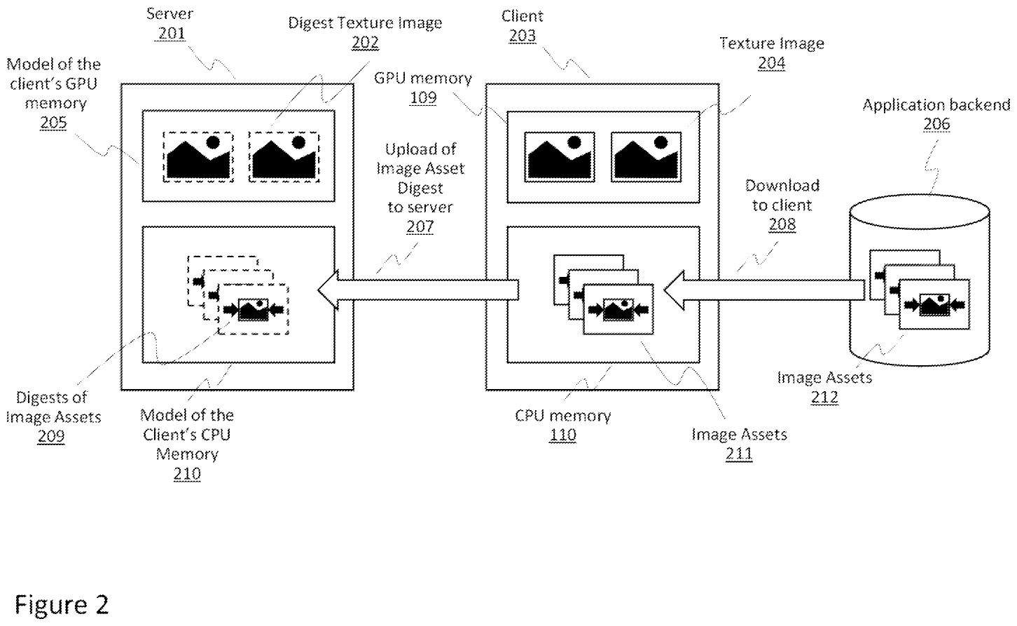

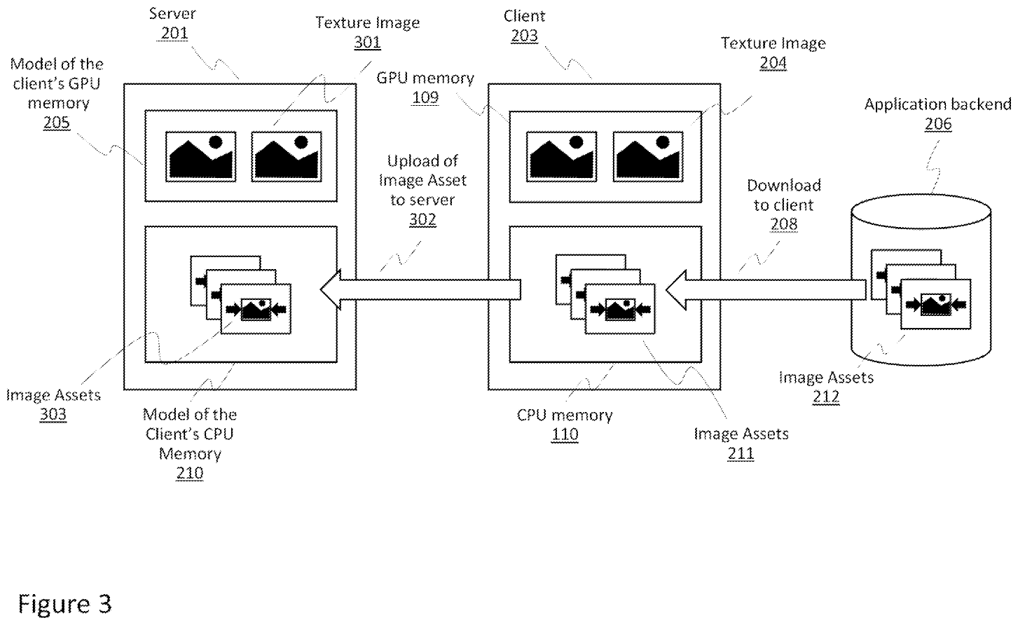

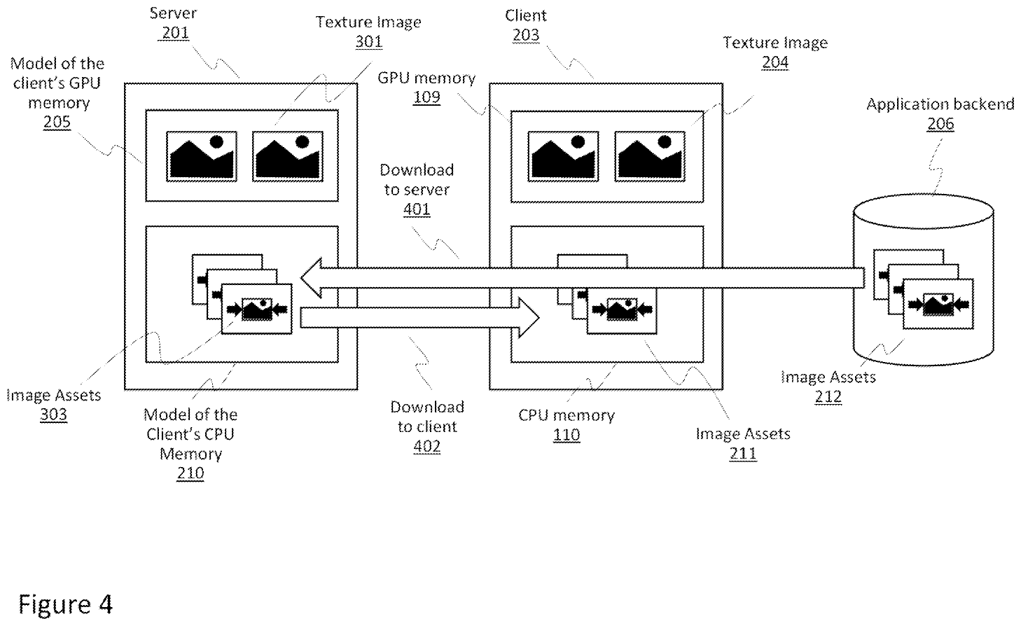

A high-level system overview, as illustrated in FIGS. 2-4, illustrate a server, a client and an application backend. The application backend 206 stores compressed image assets that are under the server's orchestration (and on behalf of the virtualized application) either downloaded to the client and forwarded to the server 201 as a digest (e.g., FIG. 2, upload digest 209), downloaded to the server 201 through the client (e.g., FIG. 3, upload image asset 302) or directly downloaded to the server (e.g., FIG. 4, download 401), bypassing the client. In some embodiments, the application backend 206 is for a third-party application (e.g., a third-party application that provides media content for playback). In some embodiments, the third-party application is executed at the server (e.g., on a virtual machine). The server may either refer to image assets downloaded by the client (and forwarded as digest) or the client may download image assets from the server. The net result is that the client has copies of image assets from the backend and the server may have either the same compressed image assets or a digest of them. The server uses these image assets or digests of image assets to construct models of the client's CPU and GPU memory architectures. The GPU memory model tracks the client's GPU memory usage and is used to decide when texture image need to be evicted from GPU memory to make room for new texture images. Texture images can be evicted by first downloading them from GPU memory to CPU memory and then removing the texture image from GPU memory. In the case where the texture image can be restored from an image asset, the downloading process can be omitted. A texture image downloaded to CPU memory may also be compressed to an image asset to conserve CPU memory space. Restoration can either happen from a compressed image asset or a texture image in CPU memory.

In teaching the server-side orchestration logic for the eviction, restoration and compression processes, it should be appreciated that there is a strict separation between the data plane and control plane. The data plane is the client downloading texture images from the GPU to the CPU, applying compression if necessary, optionally storing the downloaded texture images, decompression of image assets to new texture images and the process of uploading those texture images to the GPU. In some embodiments, none of the steps listed above is done by the client's own initiative. Everything happens under the orchestration of the server, the control plane. Hence, the flow charts describe the server-side logic to control the data plane.

In some embodiments, GPU texture image allocations 105 can be moved to CPU memory 110 on demand in real time. As one example, if a situation arose where an application needed space for four GPU texture image allocations, yet the traditional architecture, with its fixed division 102 or discrete architecture 103, might only have space for three GPU texture image allocations 109. Therefore, to accommodate for the additional texture image, one or more texture images would have to be evicted 107 from the GPU memory and (temporarily) stored in the CPU's memory 110. In contrast, the unified architecture being taught has already assigned four texture images to GPU memory and further free memory 104 is available to either assign to CPU or GPU.

A first embodiment of the process of downloading image assets 212 from an application backend 206 is given in FIG. 2. Here, the client 203 downloads 208, under the orchestration of the server 201 and on behalf of the virtualized application, image assets 211 (e.g., corresponding to image assets 212) to the client's CPU memory 110 and uploads 207 digests of those assets 209 to the server. For example, the digest of an image asset comprises a representation of the image asset without image data (e.g., to reduce bandwidth, instead of sending the full image asset that includes image data, the digest includes placeholder information (e.g., a size of the image) and strips out the image data). The client decompresses these image assets, again under the server's orchestration, into texture images 204 that are stored in the GPU's memory 109. The server uses the digests of image assets to construct models of the client's CPU (210) and GPU (205) memory. The CPU memory model stores the digests of the image assets (209), mirroring the actual storage of image assets (211) in the client's CPU memory (110). The GPU memory model (205) stores the digests of the texture images (202), mirroring the actual storage of texture images (204) in the client's GPU memory (109).

A second embodiment of the process of downloading image assets 212 from an application backend 206 is given in FIG. 3. The difference with the first embodiment is that instead of uploading digests of image assets 207, the actual image assets 211 are uploaded 302. Consequently, the server's CPU and GPU memory models (210 and 205) store the equivalent image assets (303) and texture images (301).

In a third embodiment of the process of downloading image assets from an application backend the server downloads 401 the image assets 303 directly from the application backend 206 and the client subsequently downloads 402 the image assets 211 to its CPU memory 110, as depicted in FIG. 4.

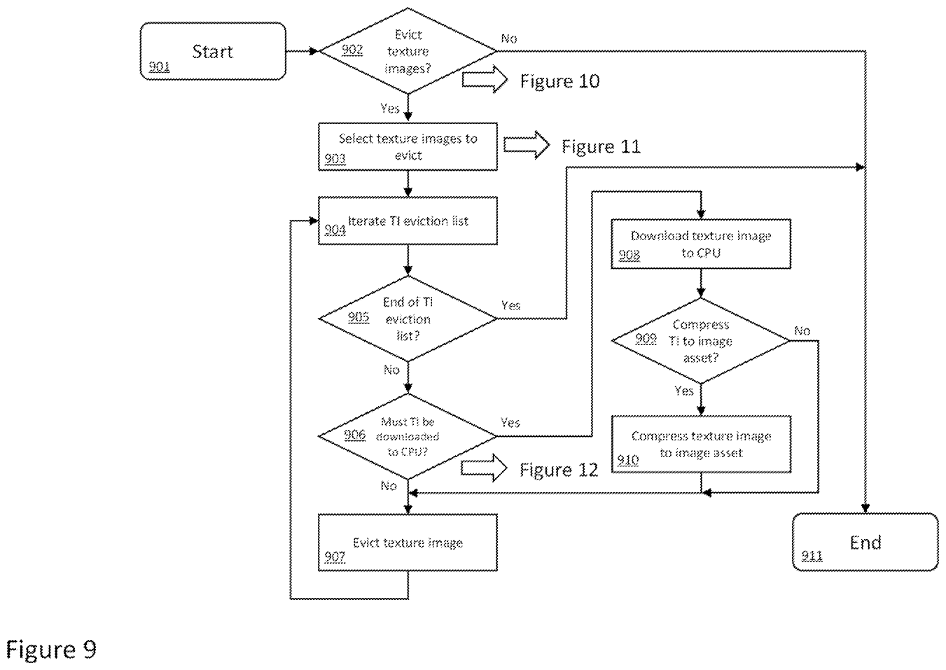

The net result of the three embodiments is that the client 203, has copies of image assets 212 from the application backend 206 and the server 201 either has the same image assets 303 or a digest 209 of them. The server's GPU memory model 205 tracks the client's GPU memory 109 usage and is used to decide, according to the decision logic taught in FIGS. 9 to 12, when and how texture images 204 are evicted from GPU memory to make room for new texture images.

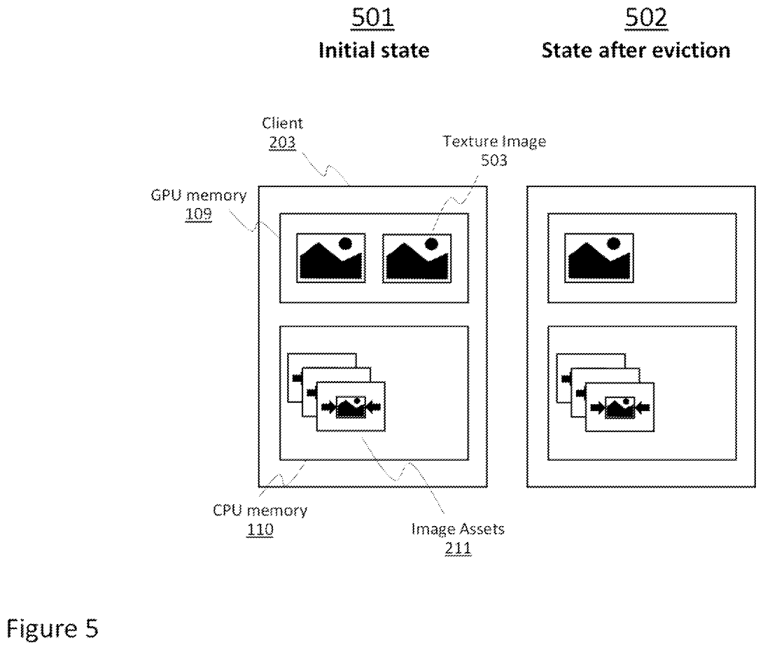

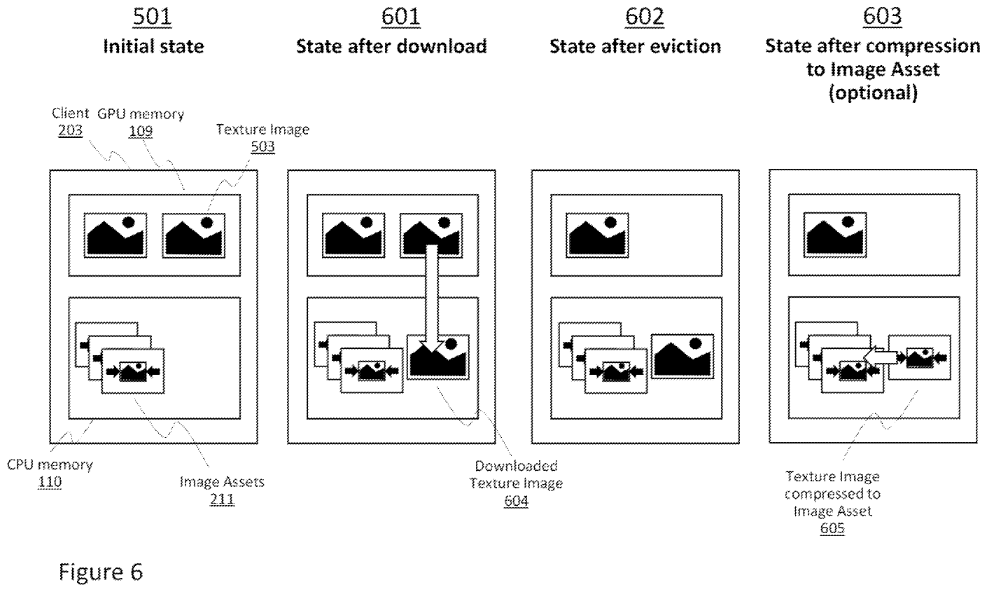

FIGS. 5 and 6 teach two embodiments of texture image eviction. The first embodiment in FIG. 5 shows the two states (501 and 502) of simple eviction where a texture image 503 is simply removed from the client's GPU memory 109. This type of eviction is used when the texture image can be restored from an image asset in the collection of texture images 211.

FIG. 6 depicts the states 501, 601-603 of an embodiment of a more elaborate eviction process. Here, the texture image 503 is first downloaded from the client's GPU memory 109 to the client's CPU memory 110. Subsequently, the texture image is evicted from GPU memory and optionally compressed to an image asset 605. This type of eviction is used when the texture image cannot be restored from an image asset in the collection of texture images 211. Whether the texture image is compressed as an image asset (603) is an implementation dependent decision where the cost of compression is balanced against the cost of keeping the raw texture image in CPU memory.

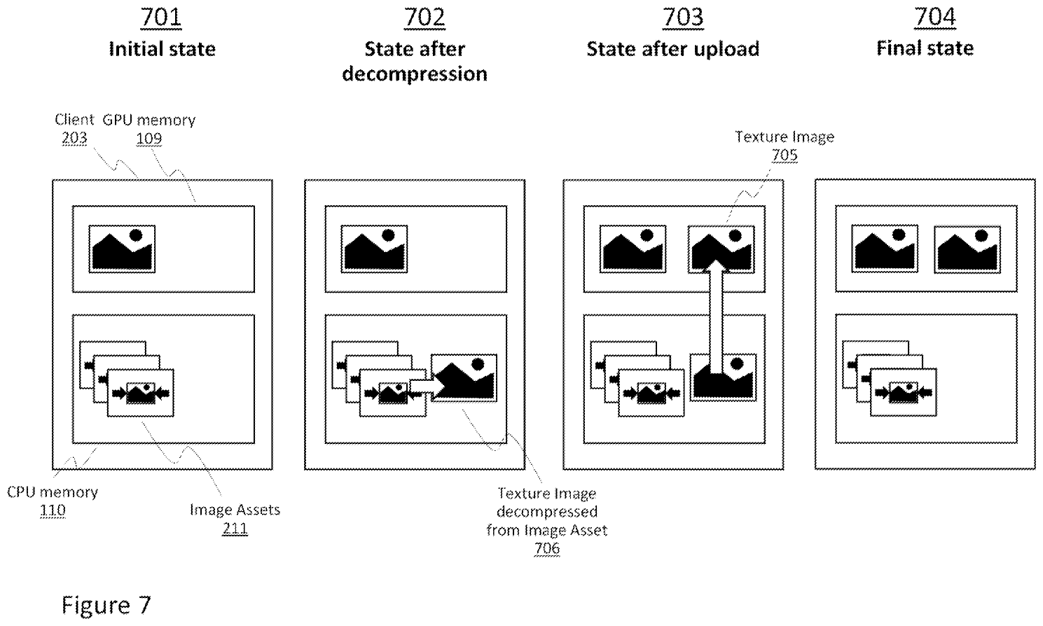

FIG. 7 depicts the states of restoring a texture image 705 from the collection of image assets 211. First, the relevant image asset is decompressed in a texture image 706. Then, the texture image is uploaded from the client's CPU memory 110 to the client's GPU memory 109. Finally, the texture image is deleted from the client's CPU memory. The final state 704 of the restoration process is equivalent to the initial state of the eviction process 501.

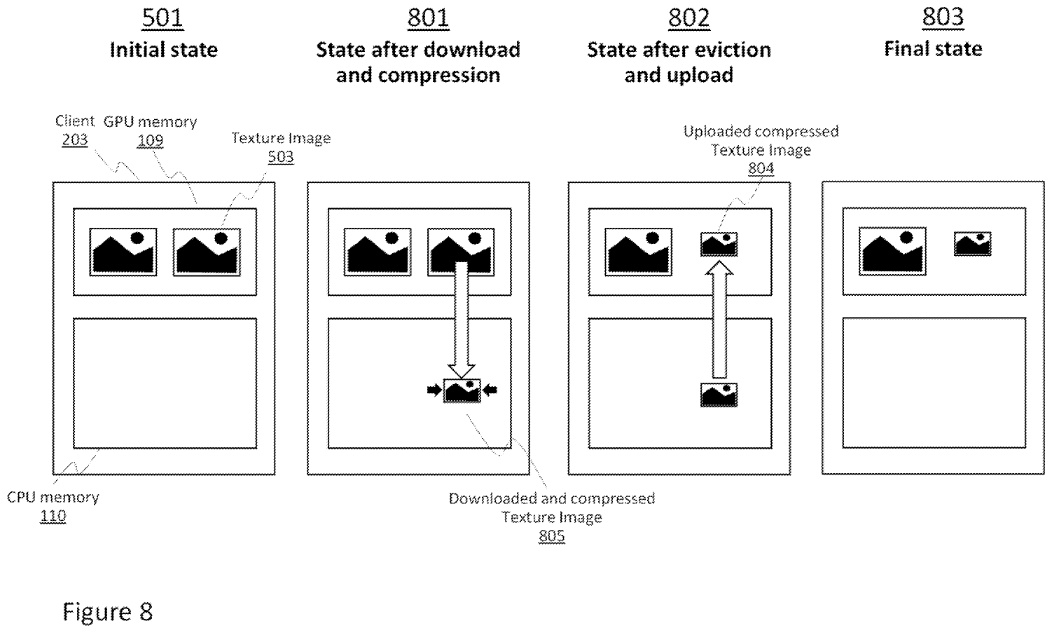

Textures images may also be stored on the GPU in a compressed format. Such texture image compression is another tool available to achieve the same goal of running an application so that it remains unaware of restrictions on available GPU memory on a GPU memory bound client. FIG. 8 teaches the client image compression process in 4 states. First, a candidate texture image is downloaded from the client's GPU memory 109 into the client's CPU memory 110 and compressed into a compressed texture format the GPU supports, such as for example, but not limited to, Ericsson Texture Compression (ETC), S3 Texture Compression (S3TC) or Adaptive Scalable Texture Compression (ASTC). Then, the compressed texture image is uploaded again to the client's GPU memory. Finally, the CPU side copy of the compressed texture image is deleted from the client's CPU memory.

In teaching the server-side orchestration logic for the eviction, restoration and compression processes, it should be appreciated that there is a strict separation between the data plane and control plane. The data plane is the client downloading image assets from the application backend 206 or server 201, texture images from the GPU's memory 109 to the CPU's memory 110, compressing the downloaded texture image to an image asset 605, decompression of images assets to texture images 706, and the process of uploading that data to the GPU 703. None of that is done by the client's own initiative. Everything happens under the orchestration of the server 201. Hence, the flow charts 9-14 describe the server-side logic to control the data plane.

It should further be appreciated that the server performs the same operations on its models of the client's CPU memory 210 GPU memory so that the model is always in sync with the state of the client. That way, the server can perform its orchestration solely based on its models and never has to query the client for its state.

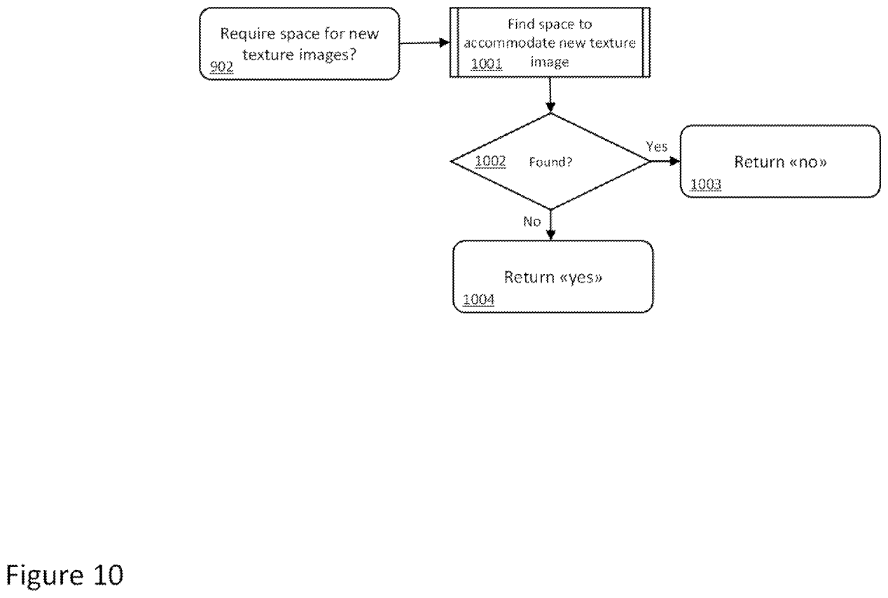

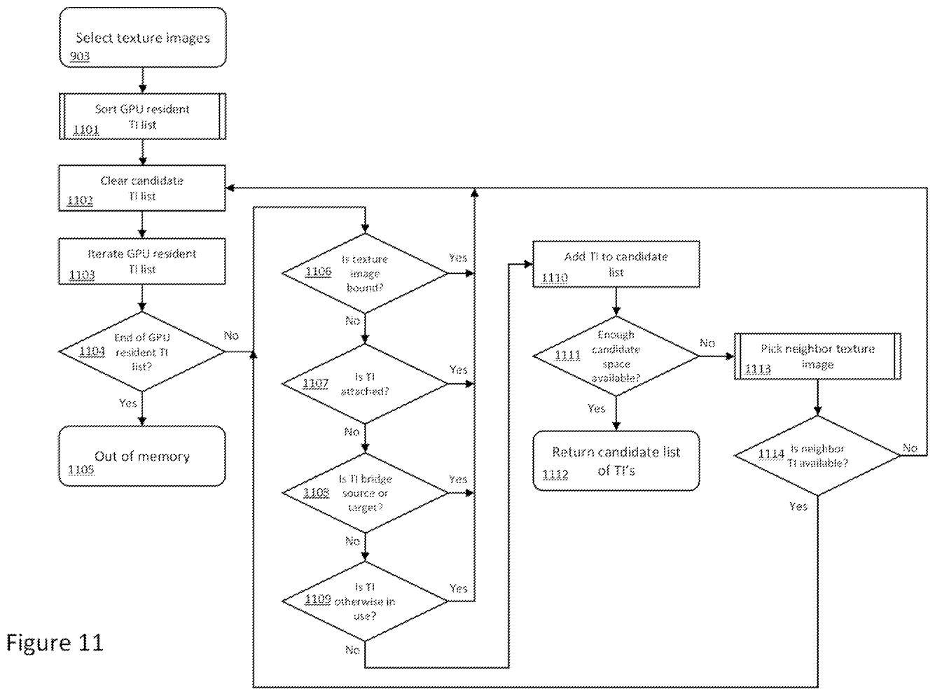

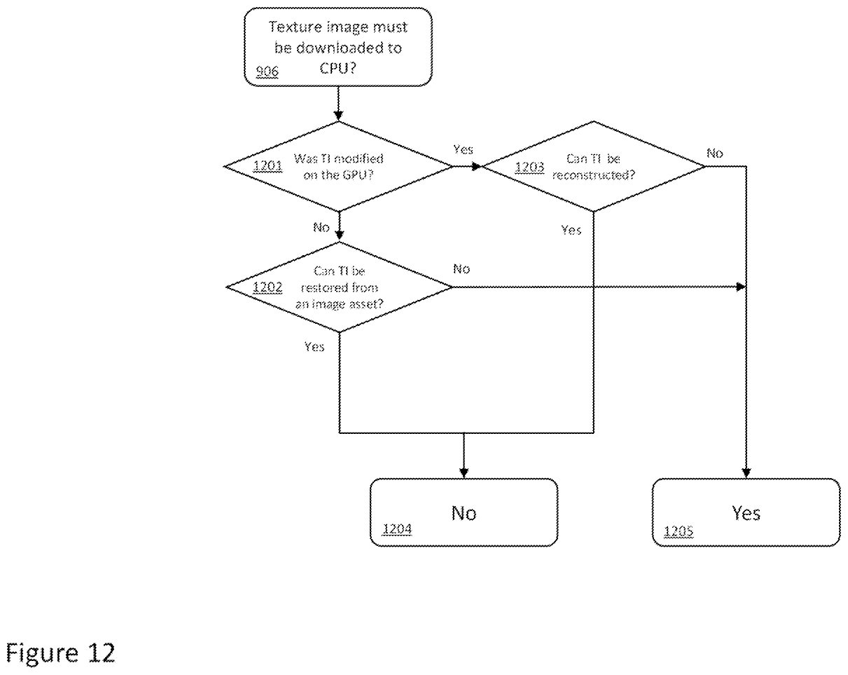

FIGS. 9 to 12 teach the server-side eviction orchestration logic that controls the client's eviction process. The logic, starting with symbol 901, is applied for each new texture image allocation. It first determines whether the new texture image allocation requires eviction of texture images 902 to accommodate the new texture allocation. The decision logic is expanded in FIG. 10. Process 1001 is an implementation dependent memory allocation scheme such as for example, but not limited to, a best-fit, worst-fit, first-fit or next-fit allocation scheme. If space is found to accommodate the new texture allocation, the process in FIG. 9 terminates with 911. If no space is found, the logic proceeds to evict texture images by selecting texture images to evict 903, expanded in FIG. 11. Process 904 iterates over the list of results from 903. When all texture images have been processed, the logic terminates with 911 because enough GPU memory was freed to accommodate the new texture image allocation. Decision 906, expanded in FIG. 12, determines whether the texture image to evict must first be downloaded to the client and optionally compressed, as performed by 908-910, or whether the texture image can be evicted immediately 907. After the texture image has been evicted, the logic returns to 904 to process the next texture image on the eviction list.

FIG. 11 is a flowchart of the selection logic for texture images that can be evicted or compressed to make space for a new texture image allocation. Process 1101 sorts all GPU resident texture images according to an implementation dependent criterion. An example of such a criterion may be Least Recently Used (LRU), however, the criterion is typically augmented with other dimensions such as minimizing the number of textures that need to be evicted, prefer simple eviction (FIG. 5) over elaborate eviction (FIG. 6), etc. After sorting the GPU resident textures, the logic proceeds with clearing the list of candidate texture images 1102. Then, it starts iterating over the texture images on the GPU resident list. Process 1104 determines whether the GPU resident texture images list has been exhausted and returns an “out of memory” condition if so. If not, it proceeds to evaluate if the current GPU resident texture image qualifies for eviction. The logic consecutively evaluates whether the texture is bound to a context 1106, attached to, for example, a framebuffer or pixel-buffer 1107, whether it is a source or target for a bridge between contexts 1108 or otherwise being used by a context 1109. If one of the decision symbols return “yes”, the logic returns to 1102 to find a new group of texture images to evict, starting with the next texture image on the list of GPU resident texture images. If all the decision symbols 1106-1109 return “no”, the current GPU resident texture image is put on the list of texture images to be evicted 1110. When the list holds enough eviction candidate texture images, that is the combined size of the texture images on the list and any available space in between them is enough to satisfy the space requirement for the new texture image allocation, the logic returns the list of eviction candidate texture images 1112. If there is not yet enough space, the tries to pick a neighbor texture image to grow candidate list 1113. This is an implementation dependent process that picks with similar criteria as process 1101. For example, the process may grow the candidate list by looking at candidate texture images before or after the current selection, depending on for example LRU, size, eviction type criteria. The neighbor must also not necessarily be directly adjacent; free space in between the current selection and the neighbor is favorable because it helps growing the available space without evictions. If a neighbor is found, the logic continues with the evaluation of the neighbor texture image 1106-1109. If no neighbor is found, the logic returns to process 1102.

FIG. 12 depicts a flowchart of the server-side logic applied to decide whether an eviction candidate texture image must be downloaded prior to eviction. It first checks whether the texture image was modified on the GPU 1201, such as for example by being attached to a framebuffer. If not, the logic proceeds to check whether the texture image can be restored from an equivalent image asset 1202. If so, it does not need to download the texture image and the texture image can simply be evicted. If an equivalent image asset is not available, the texture image must be downloaded otherwise there is no means to later restore the texture image. If the texture image was modified in the GPU domain, the logic proceeds to check whether the texture image could potentially be restored by reapplying the same operations 1203. If so, reapplying the same operations on the texture image can restore the texture image and therefore it does not need to be downloaded. If, however, it is not feasible to reconstruct the GPU domain modified texture image, it must be downloaded.

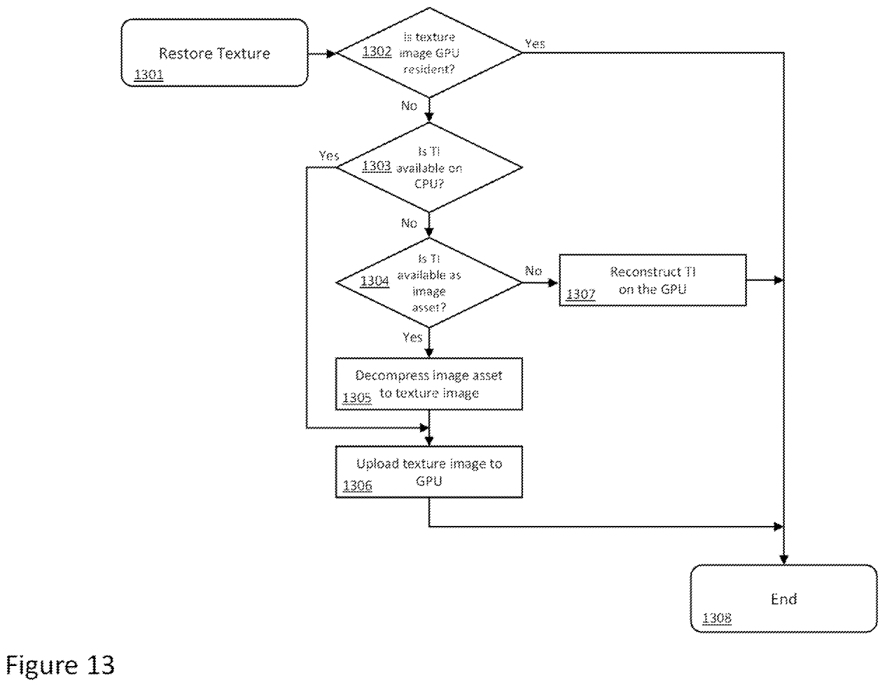

FIG. 13 teaches the server-side orchestration for texture image restoration. Texture images can be restored when they are about to be used 1301. Decision 1302 checks whether the texture image is already GPU resident. If so, the logic terminates immediately. If not, it proceeds to check whether the texture image is available in CPU memory as a texture image 1303. If it is readily available as a texture image in CPU memory, the logic skips ahead to process 1306 to upload the texture image to GPU memory. If it is not available as texture image, it checks whether it can restore the texture image from an image asset 1304, decompresses that texture image 1305 and uploads the texture image to the GPU memory 1306. If the texture image was not available as image asset, it is restored by reconstructing the texture image on the GPU 1307, for example by replaying the same GPU commands that were found in 1203.

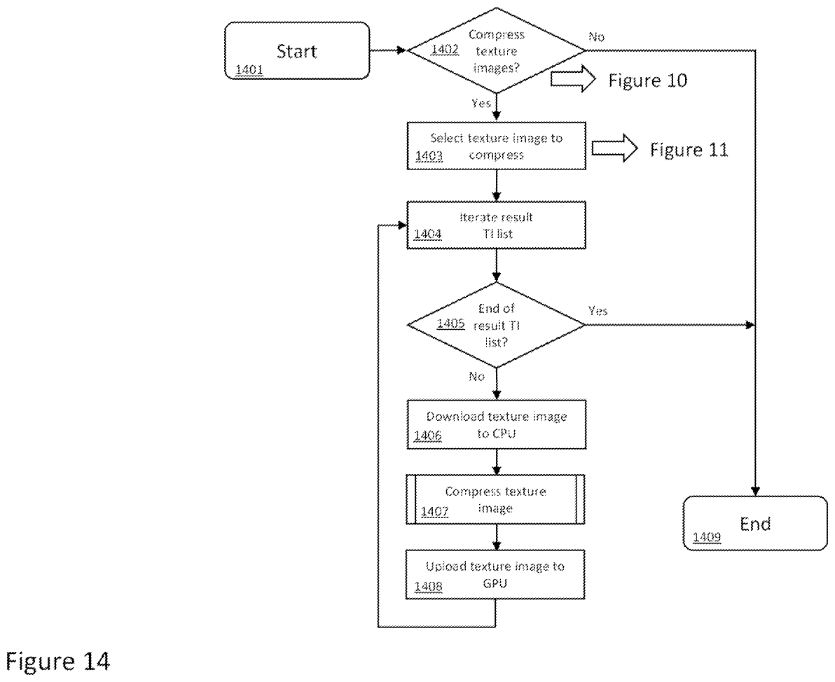

FIG. 14 is a flowchart of the server-side texture image compression orchestration logic. The general structure is very similar to FIG. 9. Decision 1402 uses the logic in the flowchart of FIG. 10 to check whether enough space is available to accommodate a new texture image allocation and terminates 1409 if the required space is found. If not, process 1403 applies the logic in the flowchart of FIG. 11 to find candidate texture images to compress. In this case 1111 considers that it also needs to store the compressed texture images. Note that this is possible because texture image compression generally has a fixed compression ratio. It subsequently iterates over the candidate texture image list in process 1404 until all candidate texture images have been compressed 1405. Texture image compression 1407 is performed by the CPU. Therefore, process 1406 first downloads and deletes the texture image from GPU memory to CPU memory. After process 1407 finishes compression of the texture image, it is again uploaded 1408 to GPU memory and the CPU side compressed texture image is deleted.

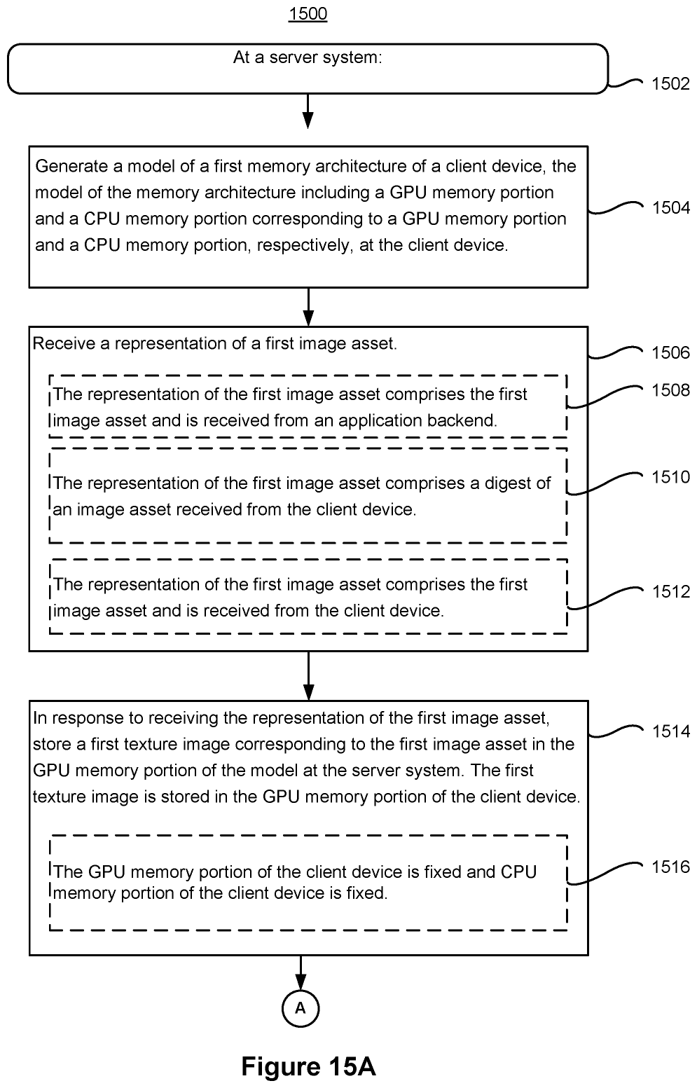

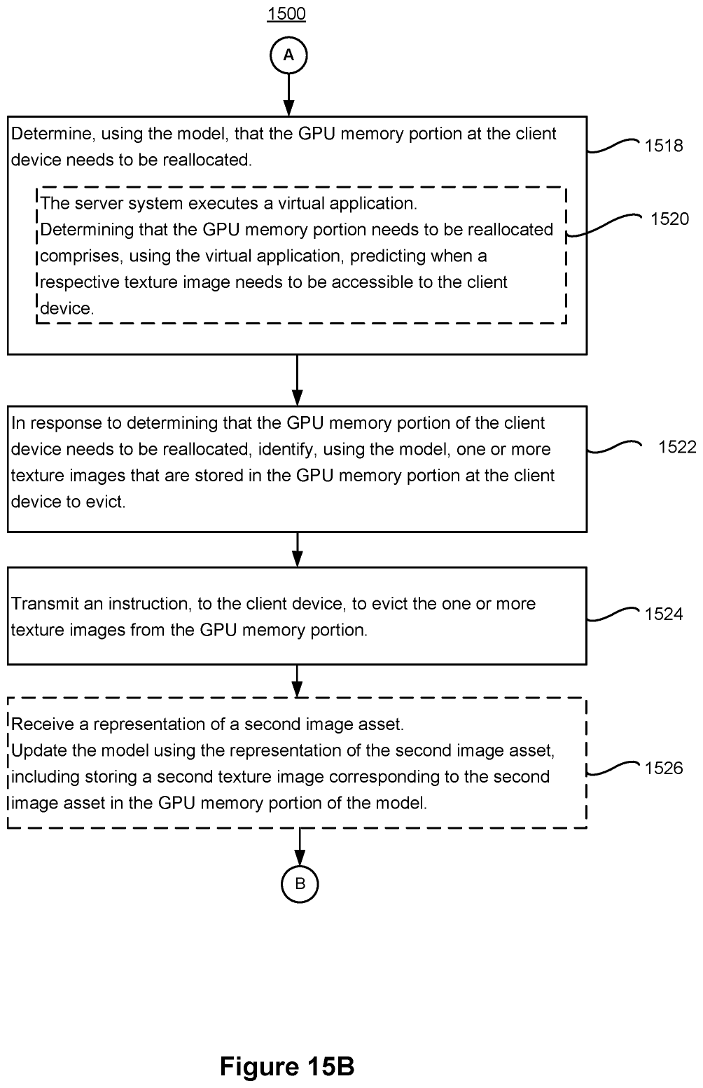

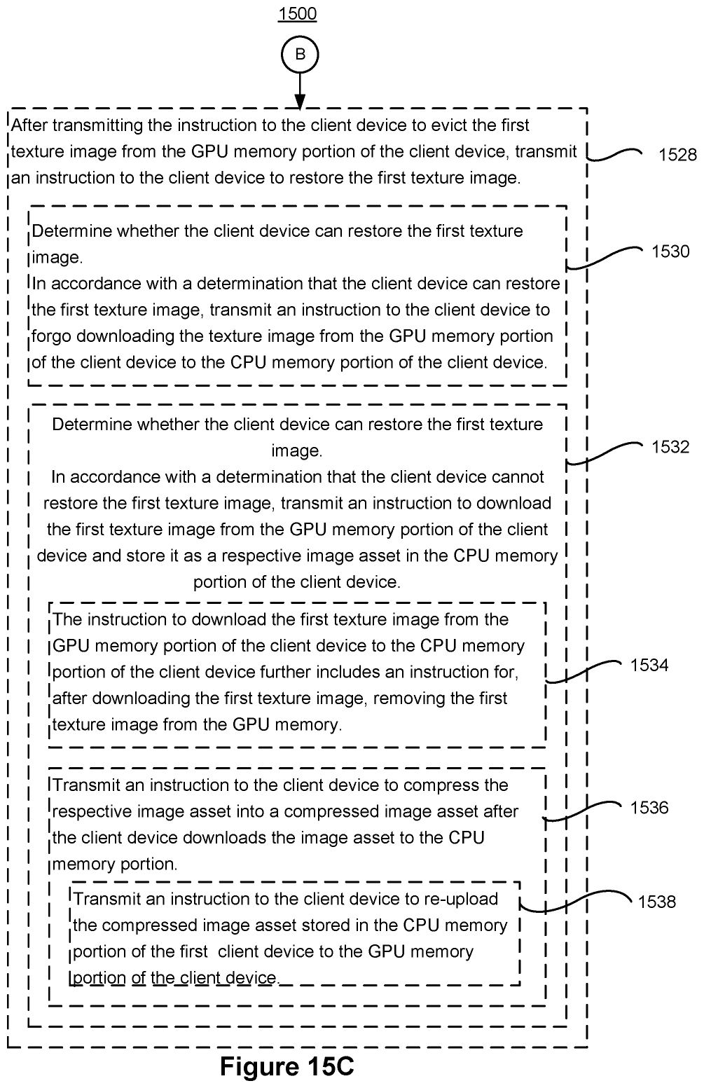

FIGS. 15A-15C illustrate a method 1500 for reallocating GPU memory at a client device. In some embodiments, the method 1500 is performed by a server computer system 1000. For example, instructions for performing the method are stored in the memory 1006 and executed by the processor(s) 1002 of the server computer system 1000. Some operations described with regard to the process 1500 are, optionally, combined and/or the order of some operations is, optionally, changed. The server computer system (e.g., a server computing device, such as server 201) has one or more processors and memory storing one or more programs for execution by the one or more processors. In some embodiments, the method 1500 is executed at a virtual machine hosted at the server system. For example, the server system hosts a plurality of virtual machines, each virtual machine corresponding to a respective client device. In this way, different memory architectures used by different clients are emulated on a respective virtual machine at the server system. Thus, if a first client implements a unified memory with fixed division architecture, a first virtual machine corresponding to the first client generates a model of the unified memory with fixed division architecture. If a second client implements a discrete memory architecture, a second virtual machine corresponding to the second client generates a model of the discrete memory architecture.

The server system generates (1504) a model of a first memory architecture of a client device, the model of the first memory architecture including a GPU memory portion and a CPU memory portion corresponding to a GPU memory portion and a CPU memory portion, respectively, at the client device.

The server system receives (1506) a representation of a first image asset.

In some embodiments, the representation of the first image asset comprises (1508) the first image asset and is received from an application backend. For example, as illustrated in FIG. 4, in some embodiments, application backend 206 downloads and image asset (e.g., image assets 303) to server 201 directly (e.g., via arrow 401). In some embodiments, after receiving the first image asset at the server system, the server system sends the image asset to client device 203 (e.g., via download to client 402).

In some embodiments, the representation of the first image asset comprises (1510) a digest of an image asset received from the client device. For example, as illustrated in FIG. 2, a digest of image asset 207 is sent from client 203 to server 201.

In some embodiments, the representation of the first image asset comprises (1512) the first image asset and is received from the client device. For example, as illustrated in FIG. 3, the image asset 302 is uploaded to server 201.

In response to receiving the representation of the first image asset, store (1514) a first texture image corresponding to the first image asset in the GPU memory portion of the model at the server system. The first texture image is stored in the GPU memory portion of the client device. In some embodiments, the model of the first memory architecture comprises emulating memory of the client device, including storing the image assets and/or texture images within the respective GPU memory portion and/or CPU memory portion of the client device.

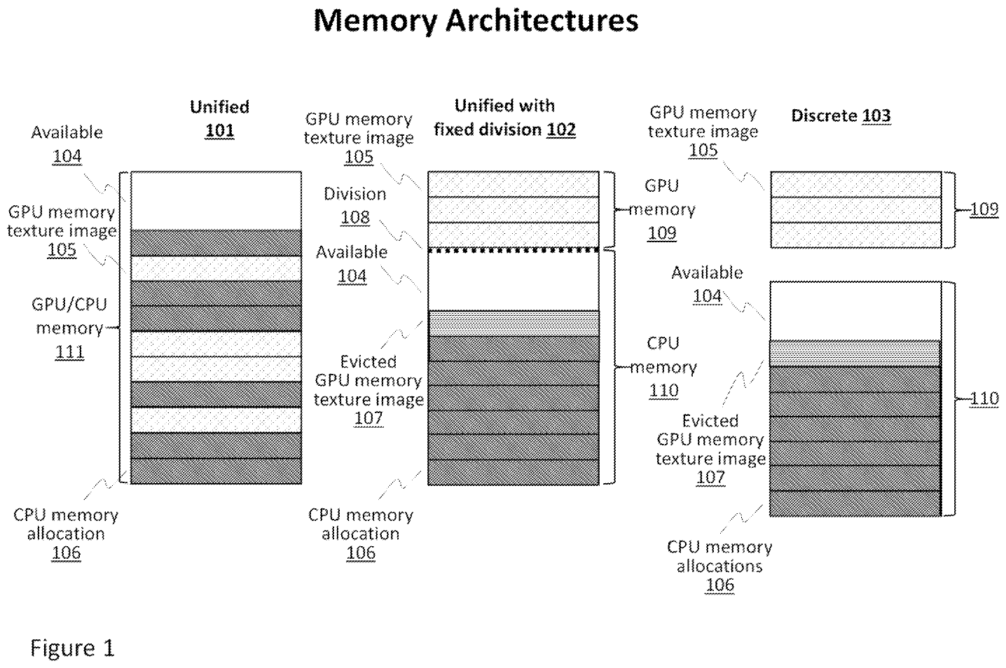

In some embodiments, the GPU memory portion of the client device is (1516) fixed and CPU memory portion of the client device is fixed. For example, as illustrated in FIG. 1, in some embodiments, the memory of the client device comprises a unified memory with fixed division 102 or discrete memory 103 (e.g., not a unified structure).

The server system determines (1518), using the model, that the GPU memory portion at the client device needs to be reallocated. For example, the server system determines that the GPU memory portion of the client device needs to accommodate new texture images that will be used by the client. In some embodiments, the server system executes an application (e.g., a media-providing application), and the server system, using the application, determines when respective texture images will be displayed. For example, as used herein, a determination that the GPU memory portion of the client needs to be “reallocated” refers to a determination that one or more texture images stored in the GPU memory portion needs to be swapped out (e.g., removed from the GPU memory portion) in order to make room for another texture image to be stored in the GPU memory portion in its place (e.g., the GPU memory portion has a limited amount of available memory that the server determines how to allocate (e.g., which texture images to store in the GPU memory at a given point in time)).

In some embodiments, the server system executes (1520) a virtual application. In some embodiments, determining that the GPU memory portion needs to be reallocated comprises, using the virtual application, predicting when (e.g., and how) a respective texture image needs to be accessible (e.g., loaded in the GPU) to the client device. For example, the server system uses the model generated at the server system without querying the client for its state.

In response to determining that the GPU memory portion of the client device needs to be reallocated, the server system identifies (1522), using the model, one or more texture images that are stored in the GPU memory portion at the client device to evict.

The server system transmits (1524) an instruction, to the client device, to evict the one or more texture images from the GPU memory portion. In some embodiments, the server system continues identifying texture images to evict from the GPU memory portion until enough GPU memory is freed to accommodate the new texture image allocation.

In some embodiments, the server system receives (1526) a representation of a second image asset. For example, the server system receiving a plurality of image assets that are generated by application backend 206 (e.g., to be displayed at the client 203). In some embodiments, the server system updates the model using the representation of the second image asset, including storing a second texture image corresponding to the second image asset in the GPU memory portion of the model. In some embodiments, the model is updated (e.g., in real-time) to reflect a current state of the client device's GPU and CPU memory allocation.

In some embodiments, after transmitting the instruction to the client device to evict a respective texture image of the one or more texture images from the GPU memory portion of the client device, the server system transmits (1528) an instruction to the client device to restore the respective texture image. In some embodiments, the instruction to restore the first texture image is transmitted in accordance with a determination that the first texture image is needed in the near future (e.g., will be used in the next frame, 5 frames, etc.). In this way, texture images are restored when they are needed for use by the GPU, and the GPU memory portion is able to dynamically allocate its memory to store texture images that are needed, and evict texture images that are not needed. If the GPU needs an texture image that is not currently stored in the GPU, then the client device needs to restore the texture image.

In some embodiments, the server system determines (1530) whether the client device can restore the respective texture image (e.g., that the client device has stored the respective texture image or a compressed version of the respective texture image (e.g., as a respective compressed texture image) to restore the respective texture image). In some embodiments, determining whether the client device can restore the respective texture image comprises determining whether the texture image has been modified on the GPU, as illustrated in FIG. 12. In accordance with a determination that the client device can restore the respective texture image, the server system forgoes transmitting an instruction to the client device to download the respective texture image from the GPU memory portion of the client device to the CPU memory portion of the client device. For example, if the client device can already restore the respective texture image by: (i) reconstructing the texture image in the GPU or (ii) restoring it from an existing image asset (e.g., that is already stored on the CPU), then the client device does not need to download the texture image to the CPU, as described with reference to FIGS. 12-13.

In some embodiments, the server system determines (1532) whether the client device can restore the respective texture image. In accordance with a determination that the client device cannot restore the respective texture image, the server system transmits an instruction to download the respective texture image from the GPU memory portion of the client device and store it as the respective texture image in the CPU memory portion of the client device.

In some embodiments, the instruction to download the respective texture image from the GPU memory portion of the client device to the CPU memory portion of the client device further includes (1534) an instruction for, after downloading the respective texture image, removing the respective texture image from the GPU memory.

In some embodiments, the server system transmits an instruction to the client device for, after downloading the respective texture image to the CPU memory portion, compressing the respective texture image into a compressed version of the respective texture image, wherein the CPU memory portion stores the compressed version of the respective texture image (e.g., and the client device, in response to the instruction, compresses the respective texture image).

In some embodiments, transmitting an instruction to the client device to re-upload the respective texture image stored in the CPU memory portion of the client device to the GPU memory portion of the client device, wherein the compressed version of the respective texture image is uploaded to the GPU memory portion of the client device.

In some embodiments, the server system transmits (1536) an instruction to the client device to compress the respective texture image asset into a compressed image asset after the client device downloads the respective texture image to the CPU memory portion, wherein the compressed image asset is stored in the CPU memory portion (e.g., as described with reference to FIG. 6). In some embodiments, the image is restored from the compressed image asset or a texture image in CPU memory. For example, FIG. 14 illustrates a flow chart of how the server system determines if the texture image should be compressed.

In some embodiments, the server system transmits (1538) an instruction to the client device to re-upload the respective texture image stored in the CPU memory portion of the client device to the GPU memory portion of the client device, including transmitting an instruction for the CPU memory portion to decompress the compressed image asset into the respective texture image before re-uploading the respective texture image to the GPU memory portion (e.g., as described with reference to FIG. 7). In some embodiments, the instruction to re-upload the respective texture image is a separate instruction from the instruction to decompress the compressed image asset. In some embodiments, the instruction to decompress the compressed image asset is included in (e.g., part of) the instruction to re-upload the respective texture image (e.g., is not a separate instruction). In some embodiments, the client device decompressed the image asset in the CPU before re-uploading it to the GPU.

In some embodiments, as illustrated in FIG. 13, the server system determines that a second texture image is needed at the client device (e.g., based on the reallocation of the GPU memory of the client device). In some embodiments, the server system determines whether the second texture image is stored in the GPU memory portion of the client device (e.g., and if it is stored, the server system sends an instruction to restore the texture image). In some embodiments, in accordance with a determination that the second texture image is not stored in the GPU memory portion of the client device, the server system determines, using the model, whether the second texture image is stored in the CPU portion of the memory of the client device (e.g., since the CPU memory portion can store both texture images and compressed image assets). In some embodiments, in accordance with a determination that the second texture image is not stored as a second image asset in the CPU portion of the memory of the client device, the server system determines whether a second image asset corresponding to the second texture image is stored in the CPU.

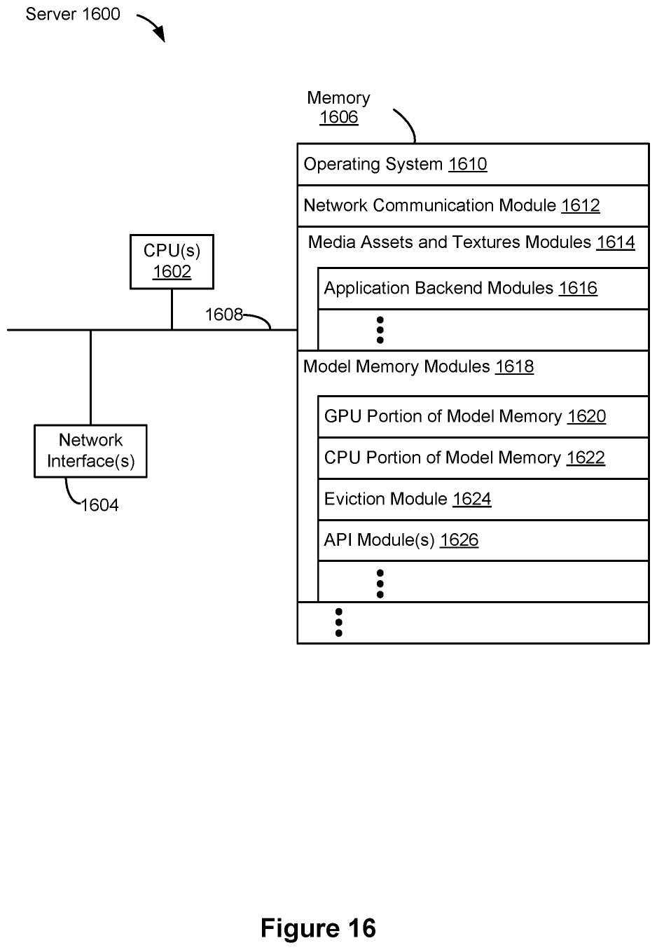

FIG. 16 is a block diagram illustrating an exemplary server computer system 1600 in accordance with some implementations. In some embodiments, server computer system 1600 is an application server that executes a virtual client virtual machine (e.g., server 201). The server computer system 1600 typically includes one or more central processing units/cores (CPUs) 1602, one or more network interfaces 1604, memory 1606, and one or more communication buses 1608 for interconnecting these components.

Memory 1606 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 1606, optionally, includes one or more storage devices remotely located from one or more CPUs 1602. Memory 1606, or, alternatively, the non-volatile solid-state memory device(s) within memory 1606, includes a non-transitory computer-readable storage medium. In some implementations, memory 1606, or the non-transitory computer-readable storage medium of memory 1606, stores the following programs, modules and data structures, or a subset or superset thereof:
an operating system 1610 that includes procedures for handling various basic system services and for performing hardware dependent tasks;
a network communication module 1612 that is used for connecting the server computer system 1600 to other computing devices via one or more network interfaces 1604 (wired or wireless) connected to one or more networks such as the Internet, other WANs, LANs, PANs, MANs, VPNs, peer-to-peer networks, content delivery networks, ad-hoc connections, and so on;
one or more media assets and textures modules 1614 for enabling the server computer system 1600 to perform various functions, the media assets modules 1614 including, but not limited to:
   application backend modules 1616 for retrieving and/or processing media content (e.g., image assets) received, for example, from application backend 206;
one or more model memory modules 1618 for generating one or more models that emulate a memory architecture of respective client devices; in some implementations, the one or more model memory modules 1618 include:
   GPU portion of model memory 1620 for tracking (e.g., emulating) and/or storing texture images stored in a GPU portion of the memory of the client device;
   CPU portion of model memory 1622 for tracking (e.g., emulating) and/or storing texture images and image assets that are stored in a CPU portion of the memory of the client device;
   Eviction module 1624, for determining which media assets to evict from the GPU portion of the memory (e.g., GPU portion of the model memory and/or GPU portion of the client memory); and
   API module(s) 1626 for calling and/or using APIs, including an API of a third-party application (e.g., an application of a media-provider).

In some implementations, the server computer system 1600 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Although FIG. 16 illustrates the server computer system 1600 in accordance with some implementations, FIG. 16 is intended more as a functional description of the various features that may be present in one or more media content servers than as a structural schematic of the implementations described herein. In practice, items shown separately could be combined and some items could be separated. For example, some items shown separately in FIG. 16 could be implemented on single servers and single items could be implemented by one or more servers. The actual number of servers used to implement server computer system 1600, and how features are allocated among them, will vary from one implementation to another and, optionally, depends in part on the amount of data traffic that the server system handles during peak usage periods as well as during average usage periods.

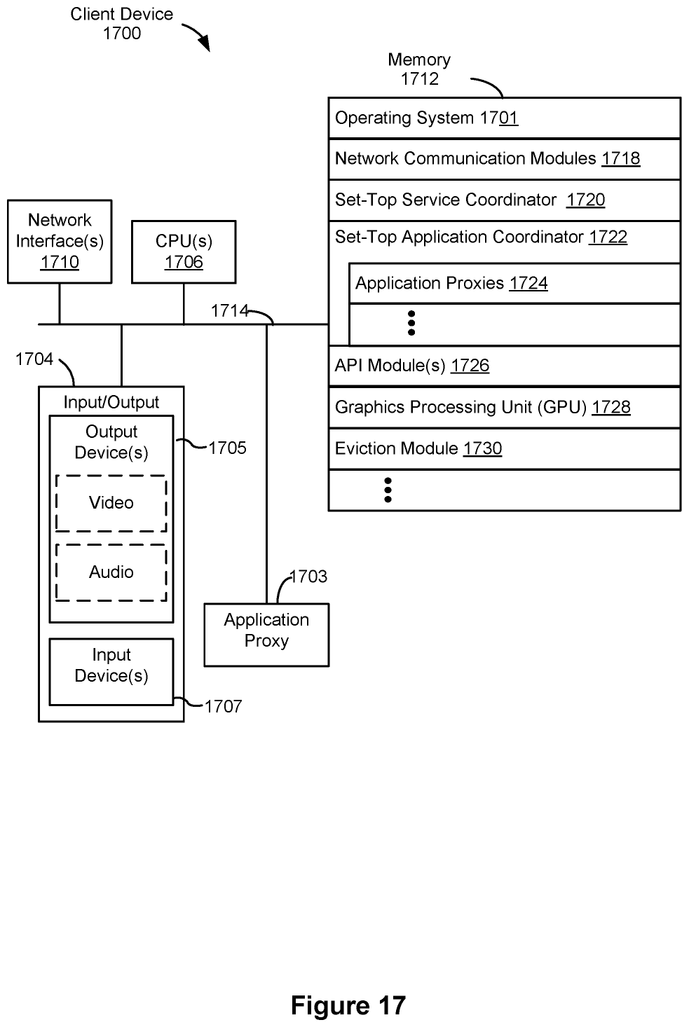

FIG. 17 is a block diagram illustrating an exemplary client device 1700 (e.g., client device 203) in accordance with some implementations. The client device 1700 typically includes one or more central processing units (CPU(s), e.g., processors or cores) 1706, one or more network (or other communications) interfaces 1710, memory 1708, and one or more communication buses 1714 for interconnecting these components. The communication buses 1714 optionally include circuitry (sometimes called a chipset) that interconnects and controls communications between system components.

The client device includes input/output module 1704, including output device(s) 1705, such as video output and audio output, and input device(s) 1707. In some implementations, the input devices 1707 include a keyboard, a remote controller, or a track pad. For example, output device 1705 is used for outputting video and/or audio content (e.g., to be reproduced by one or more displays and/or loudspeakers coupled with client device 1700) and/or input device 1707 is used for receiving user input (e.g., from a component of client device 1700 (e.g., keyboard, mouse, and/or touchscreen) and/or a control coupled to client device 1700 (e.g., a remote control)). Alternatively, or in addition, the client device includes (e.g., is coupled to) a display device (e.g., to display video output).

The client device includes application proxy 1703 for communicating with third-party applications that are executing on the server system. For example, instead of storing and executing the application(s) on the client device, application proxy 1703 receives commands (e.g., from a virtual machine in the server system) and, based on the received commands, instructs the client device to update the display accordingly.

In some implementations, the one or more network interfaces 1710 include wireless and/or wired interfaces for receiving data from and/or transmitting data to other client devices 1700, a server computer system 1600, and/or other devices or systems. In some implementations, data communications are carried out using any of a variety of custom or standard wired protocols (e.g., USB, Firewire, Ethernet, etc.).

Memory 1712 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 1712 may optionally include one or more storage devices remotely located from the CPU(s) 1706. Memory 1712, or alternately, the non-volatile memory solid-state storage devices within memory 1712, includes a non-transitory computer-readable storage medium. In some implementations, memory 1712 or the non-transitory computer-readable storage medium of memory 1712 stores the following programs, modules, and data structures, or a subset or superset thereof:
an operating system 1701 that includes procedures for handling various basic system services and for performing hardware dependent tasks;
network communication module(s) 1718 for connecting the client device 1700 to other computing devices (e.g., client devices 203, server computer system 160, and/or other devices) via the one or more network interface(s) 1710 (wired or wireless);
a set-top service coordinator 1720 for communicating with an operator data center for handling content services provided to the client device (e.g., set-top box);
a set-top application coordinator 1722 for managing a plurality of third-party applications executing at the server system, the set-top application coordinator having additional module(s), including but not limited to:
   one or more application proxies 1724 for communicating (e.g., graphical states) with third-party applications;
API Module(s) 1726 for managing a variety of APIs, including, for example, OpenGL and/or OpenMAX;
Graphics Processing Unit (GPU) 1728 for storing graphical content, including texture images, to be displayed at the client device; and
An eviction module 1730 for evicting one or more texture images from the GPU in accordance with instructions received from a server (e.g., server 1600).

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 1606 and the memory 1712) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. In some embodiments, the memory 1606 and the memory 1712 include one or more storage devices remotely located from the CPU(s) 1602 and 1706. The memory 1006 and the memory 1712, or alternatively the non-volatile memory device(s) within these memories, comprises a non-transitory computer readable storage medium.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method comprising:
at a server system:
generating a model of a first memory architecture of a client device, the model of the first memory architecture including a GPU memory portion and a CPU memory portion corresponding to a GPU memory portion and a CPU memory portion, respectively, at the client device;
receiving a representation of a first image asset;
in response to receiving the representation of the first image asset, storing a first texture image corresponding to the first image asset in the GPU memory portion of the model at the server system, wherein the first texture image is stored in the GPU memory portion of the client device;
determining, using the model, that the GPU memory portion at the client device needs to be reallocated;
in response to determining that the GPU memory portion of the client device needs to be reallocated, identifying, using the model, one or more texture images that are stored in the GPU memory portion at the client device to evict; and
transmitting an instruction, to the client device, to evict the one or more texture images from the GPU memory portion.

2. The method of claim 1, wherein the GPU memory portion of the client device is fixed and the CPU memory portion of the client device is fixed.

3. The method of claim 1, wherein the representation of the first image asset comprises the first image asset and is received from an application backend.

4. The method of claim 1, wherein the representation of the first image asset comprises a digest of an image asset received from the client device.

5. The method of claim 1, wherein the representation of the first image asset comprises the first image asset and is received from the client device.

6. The method of claim 1, further comprising:
receiving a representation of a second image asset; and
updating the model using the representation of the second image asset, including storing a second texture image corresponding to the second image asset in the GPU memory portion of the model.

7. The method of claim 1, further comprising, after transmitting the instruction to the client device to evict a respective texture image of the one or more texture images from the GPU memory portion of the client device, transmitting an instruction to the client device to restore the respective texture image.

8. The method of claim 7, further comprising,
determining whether the client device can restore the respective texture image; and
in accordance with a determination that the client device can restore the respective texture image, forgoing transmitting an instruction to the client device to download the respective texture image from the GPU memory portion of the client device to the CPU memory portion of the client device.

9. The method of claim 7, further comprising:
determining whether the client device can restore the respective texture image; and
in accordance with a determination that the client device cannot restore the respective texture image, transmitting an instruction to download the respective texture image from the GPU memory portion of the client device and store the respective texture image in the CPU memory portion of the client device.

10. The method of claim 9, wherein the instruction to download the respective texture image from the GPU memory portion of the client device to the CPU memory portion of the client device further includes an instruction for, after downloading the first respective image, removing the respective texture image from the GPU memory portion.

11. The method of claim 10, further comprising, transmitting an instruction to the client device to, after downloading the respective texture image to the CPU memory portion, compress the respective texture image into a compressed version of the respective texture image, wherein the CPU memory portion stores the compressed version of the respective texture image.

12. The method of claim 11, further comprising, transmitting an instruction to the client device to re-upload the respective texture image stored in the CPU memory portion of the client device to the GPU memory portion of the client device, wherein the compressed version of the respective texture image is uploaded to the GPU memory portion of the client device.

13. The method of claim 10, further comprising, transmitting an instruction to the client device to compress the respective texture image into a compressed image asset after the client device downloads the respective texture image to the CPU memory portion, wherein the compressed image asset is stored in the CPU memory portion.

14. The method of claim 13, further comprising, transmitting an instruction to the client device to re-upload the respective texture image stored in the CPU memory portion of the client device to the GPU memory portion of the client device, including transmitting an instruction to the CPU memory portion to decompress the compressed image asset into the respective texture image before re-uploading the respective texture image to the GPU memory portion.

15. The method of claim 1, wherein:
the server system executes a virtual application; and
determining that the GPU memory portion needs to be reallocated comprises, using the virtual application, predicting when the respective texture image needs to be accessible to the client device.

16. A computer readable storage medium storing one or more programs for execution by a server system, the one or more programs including instructions for:
generating a model of a first memory architecture of a client device, the model of the first memory architecture including a GPU memory portion and a CPU memory portion corresponding to a GPU memory portion and a CPU memory portion, respectively, at the client device;
receiving a representation of a first image asset;
in response to receiving the representation of the first image asset, storing a first texture image corresponding to the first image asset in the GPU memory portion of the model at the server system, wherein the first texture image is stored in the GPU memory portion of the client device;
determining, using the model, that the GPU memory portion at the client device needs to be reallocated;
in response to determining that the GPU memory portion of the client device needs to be reallocated, identifying, using the model, one or more texture images that are stored in the GPU memory portion at the client device to evict; and
transmitting an instruction, to the client device, to evict the one or more texture images from the GPU memory portion.

17. A server system, comprising:
one or more processors; and
memory storing one or more programs for execution by the one or more processors, the one or more programs including instructions for:
generating a model of a first memory architecture of a client device, the model of the first memory architecture including a GPU memory portion and a CPU memory portion corresponding to a GPU memory portion and a CPU memory portion, respectively, at the client device;
receiving a representation of a first image asset;
in response to receiving the representation of the first image asset, storing a first texture image corresponding to the first image asset in the GPU memory portion of the model at the server system, wherein the first texture image is stored in the GPU memory portion of the client device;
determining, using the model, that the GPU memory portion at the client device needs to be reallocated;
in response to determining that the GPU memory portion of the client device needs to be reallocated, identifying, using the model, one or more texture images that are stored in the GPU memory portion at the client device to evict; and
transmitting an instruction, to the client device, to evict the one or more texture images from the GPU memory portion.
